(19) United States
(12) Patent Application Publication
(10) Pub. No.: US 2002/0175821 A1
(43) Pub. Date: Nov. 28, 2002

(54) SLEEP DELAY APPARATUS FOR DRIVERS

(76) Inventor: Edward G. Ruppel, Lawrenceville, IL (US)

Correspondence Address: Edward G. Ruppel, 1917 S. 15th Street, Lawrenceville, IL, 62439-2233, US

(21) Appl. No.: 09/826,155

(22) Filed: Apr. 4, 2001

(51) Int. Cl. G08B 23/00

(52) U.S. Cl. 340/575; 340/576; 340/407.1

(57) ABSTRACT

This invention relates to an apparatus to aid drivers by delaying the onset of drowsiness and its tendency toward slow response time and brief periods of micro sleep. The preferred embodiment uses two thermoelectric modules mounted on a belt and positioned under the armpits. The modules are most effective when placed in contact with the skin but still effective if placed over light clothing. Manual activation of the unit is preferred but it has input for optional head tilt sensor or eyelid closure sensor. It quietly alarms by sequentially cooling one of the thermoelectric modules while the other thermoelectric module is warmed slightly above body temperature. The sequential pulse driving cycle is controlled by a remote timer located in a small enclosure which is powered from a cigarette lighter plug. The drive signal duration and thus the level of alarm is controlled with a multi-position control on the enclosure.

### BACKGROUND

Since an increase in the number of accidents and deaths caused by drowsy and sleeping drivers is alarming, the present invention relates to sleep prevention for drivers and more particularly to a silent irritation device to alert the driver.

The major portion of our research and development was conducted by a survivor of a major highway accident on Jun. 24, 1994, which was caused by said survivor going to sleep at the wheel. Said survivor (who has a nuro sleep apnea problem) normally cannot drive more than thirty five miles without becoming drowsy. A prototype of the present invention was tested over several thousand miles of driving with a few trips being non-stop for two hundred miles and the invention kept the driver alert. Said invention is treated as a trade secret.

### DESCRIPTION OF PRIOR ART

Sleep prevention devices are known, being disclosed for example in U.S. Pat. Nos. 5,559,495 to Cochran, 4,144,531 to Anbergen and 5,682,144 to Mannik. The Cochran and Anbergen patents using a speaker alarm would be less effective under noisy conditions such as having a radio playing. The Mannik patent using a buzzer would also be less effective under said noisy conditions. Some users are slow to react to an audible alarm. Visual means of alarm would be less effective under conditions of bright sunlight.

While an audible alert is workable for most people; some do not respond rapidly to an audible alarm. This invention prefers the user being able to recognize the onset of drowsiness and manually starting the timing of the sleep delay apparatus. As a backup the apparatus would be started with an eyelid closure detector such as the “Drowsiness detecting apparatus” by Anbergen U.S. Pat. No. 4,144,531, Mar. 13, 1979 or one of many available head tilt sensors.

This invention in combination uses:

the cold side of a thermoelectric module;

heat sinks mounted on the hot side of thermoelectric modules mounted on a belt or on a variety of possible mounting structures;

a module enclosure containing a plurality of sequential timers, a number of drivers, a manual starting switch, a sensor input for any number of backup sleep detectors, a leveling detector for use with head tilt sensors, and intensity level switch with a plurality of settings, and a means to get fused power input.

The preferred use of the sleep delay apparatus uses in combination:

a thermoelectric module under each armpit mounted on a belt with a quick release and an elastic section to allow expansion;

a control module with four (4) sequential timers;

a DPDT level switch with three (3) settings;

a SPST momentary start switch;

four (4) LED's to indicate which timer is operating;

a quick disconnect cable which goes to the alarm belt modules;

and a power cable.

### SUMMARY OF THE INVENTION

An object of the present invention is to delay the onset of drowsiness until the tendency to be drowsy has passed or a place to sleep may become available.

Another object of this invention is to quietly irritate the user into becoming more alert.

A further object of this invention is to cause the generic thermoelectric modules by way of timed pulses to act as an irritation module.

A further object of the invention is to use readily available generic parts, and be inexpensive to manufacture.

For other objects and a better understanding of the invention, reference may be made to the following detailed description taken in conjunction with the accompanying drawings.

### BRIEF DESCRIPTION OF THE DRAWINGS

FIG. 1 is a front view of the preferred embodiment.

FIG. 2 is an end view of the thermoelectric module.

FIG. 3 is a side view of the thermoelectric module.

FIG. 4 is a view of the thermoelectric mounted on a body belt.

FIG. 5 is an outside top view of the pulse generator and control unit.

FIG. 6 is an inside block diagram of the pulse generator and control unit.

FIG. 7 is an interconnecting block diagram.

### DETAILED DESCRIPTION OF THE FIGURES

| | |
|---|---|
| 10A. & 10B. Edge view of | 11. Thermoelectric junction. |
| thermoelectric module. | |
| 12. Thermoelectric junction heat sink. | 13. Body cold and warm plate. |
| 14. Two-inch webbed belt. | 15. Eight-inch section of elastic. |
| 16. Quick release adjustable buckle. | 17. Interconnection cable. |
| 18. Control and pulse generator module. | 19. Enclosure and mounting |
| | flange. |
| 20. Power input jack. | 21. Interconnecting cable jack. |
| 22. Momentary manual button. | 23. Three-position intensity level |
| | switch. |
| 24. External sensor input jack. | 25. Tilt level indicator. |
| 26-29. Pulse indicator LED. | 30. Main off-on switch. |
| 31. Printed circuit board. | 32. Small parts area. |
| 33. Sequential timer and pulse | |
| generator #1. | |
| 34. Sequential timer and pulse | |
| generator #2. | |
| 35. Sequential timer and pulse | |
| generator #3. | |
| 36. Sequential timer and pulse | |
| generator #4. | |
| 37. Pulse driver relay #1. | 38. Pulse driver relay #2. |
| 39. Pulse driver relay #3. | 40. Pulse driver relay #4. |
| 41. Fused cigarette lighter plug. | |

### DESCRIPTION OF PREFERRED EMBODIMENT

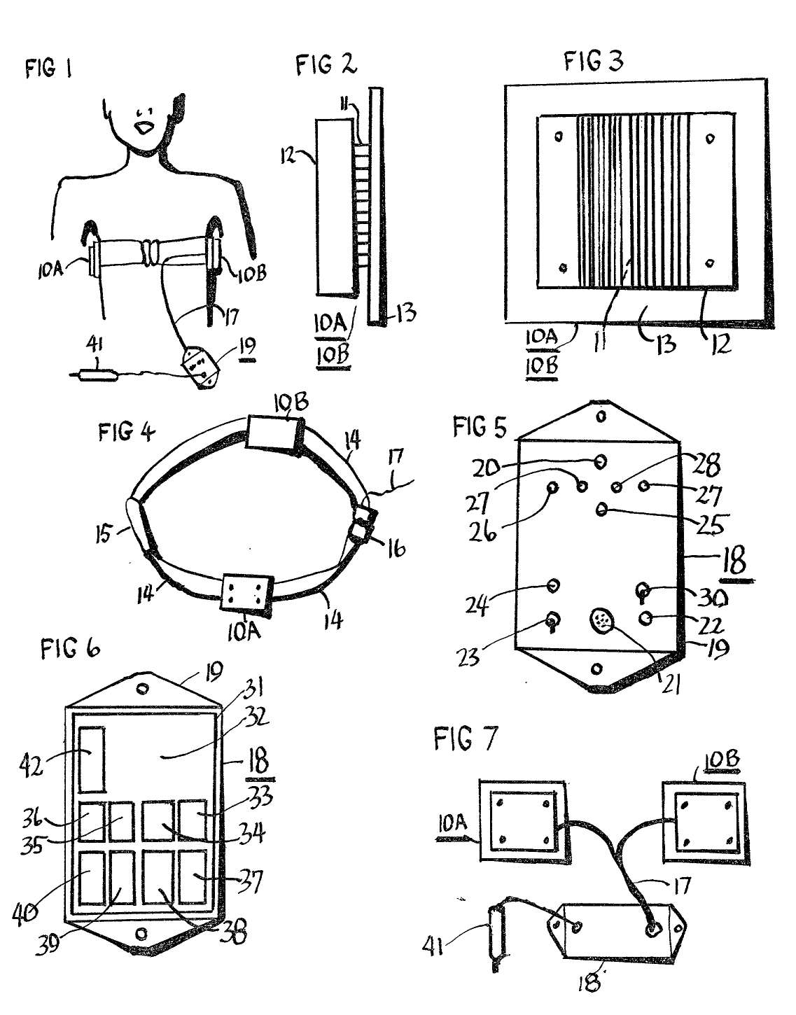

Referring to FIG. 2 of the drawing the size of is the thermoelectric module 10A and 10B is 0.17″W×0.17″L×0.12″D. This is the size preferred from among many sizes available. When an electric current is passed through the thermoelectric junction 11 one side increases in temperature while the opposite side of said junction decreases in temperature. Heat sink 12 applied to the hot side of the thermoelectric junction over a layer of heat sink compound. The preferred size for the heat sink 12 is 2.25″W×2.375″L×0.44″D. Cold plate 13 is a 3.0″W×3.25″L×0.25″ thick aluminum cold plate to be applied to the cold side of the thermoelectric junction 10 over heat sink compound. FIG. 1 shows two units explained in FIG. 2 attached to a belt located over a sensitive area under the armpits. The preferred position is against the skin. It may be worn over clothing but the effectiveness of the device is decreased as the clothing thickness is increased.

FIG. 4 shows the 2″ belt 14 with an elastic section 15 eight inches long and quick release buckle 16. Also shown are the two thermoelectric modules 10A & 10B mounted on the belt and and connected to cable 17.

FIG. 4 is a view of the top of the timer control unit 18. 19 is the case, 20 is the power input socket. LED's 26, 27, 28, 29 are the LED's showing which output driver is energized. LED 25 lights when the optional head tilt sensor is unlevel. Said LED 25 enables one to level said sensor to compensate for a normal tilt of the head. 30 is the main off/on SPST toggle switch. 24 is the backup external sensor input jack for an eyelid sensor or a head tilt sensor. 23 is a three position DPDT off/on switch wired to allow a low, medium and high setting for the driver to the thermoelectric module.

SPST momentary pushbutton switch 22 in FIG. 5 which is used to manually start the sequential timers into operation. Socket 21 is connected to the cable going to the alarm belt. FIG. 6 shows the main components in the timer control box. Printed circuit 31 is for mounting the parts. Area 32 is where the assisting parts for the timers are located. First timer 33 drives 37 output SPST relay. Second timer 34 drives numeral 38 output SPST relay. Third timer 35 drives numeral 39 output SPST relay. Fourth timer 36 drives 40 output SPST relay. Enclosure box 19 has mounting tabs and a removable lid.

The manner of operation is as follows: Power for the unit is enabled by switch 30. The unit is in ready status until either switch 22 is momentarily depressed or an input signal is received from the input sensor jack 24. This signal activates timer 33 which is set for fifteen to thirty seconds with said timer duration dependent on the power level setting of switch 23. Timer 33 drives relay 37 causing thermoelectric module 10A to rapidly get cold. Timer 34 sequences after timer 33 and runs for one minute. The output relay 38 from pulse generator 34 is connected to LED 27, but in this embodiment said relay isn't connected to a thermoelectric module. Timer 35 sequences after 34. Timer 35 has the same pulse duration as timer 33. Timer 35 drives relay 34 and thermoelectric module 10B. Timer 36 sequences after timer 35. Timer 36 has the same pulse duration as timer 34 with relay 40 connected to LED 29 but isn't connected to a thermoelectric module. The sequence is repeated by timer 36 activating timer 33. When timer 33 pulse goes to zero volts it will be approximately two minutes and twenty seconds before said timer produces another pulse. During this two minute and twenty second delay the heat from the heat sink 12 of thermoelectric module 10A tries to equalize by conducting back through the thermoelectric junction 11 to the cooling plate 13 of said module causing the temperature of said plate to rise and then settle down to near body temperature before the next pulse arrives.

The warming of thermoelectric plate 13 on 10A occurs while thermoelectric plate 13 on 10B is cooling. This alternating cooling and heating irritates and breaks the monotony for drivers.

Another advantage of the present invention is that it encourages the driver to sit with proper posture. When in a slouched position the skin folds over the top of the thermoelectric cooling plate 13 and touches heat sink 12. Said heat sink is very warm. Conversely the driver can intentionally slouch to get some extra irritation if needed. The width of the thermoelectric cooling plate 13 can be made in smaller or larger dimensions to accommodate either a slim person or an overweight person.

Once the sequencing of a pulse generator is started said generator cannot be restarted by activation of the manual start switch 22 or an activating signal from the external input jack 24. This prevents an accidental start signal causing a thermoelectric junction to overheat and is prevented with the four input “OR” gate.

What is claimed is:

1. An apparatus to delay drowsiness and sleep for drivers and others comprised of:
one or more thermoelectric modules mounted on a variety of mounting structures touching sensitive locations on the user's body;
a control unit to supply said modules with pulsed drive signal defining module on and off times;
a means of coupling the sequenced pulse drive signals from the control unit to the thermoelectric modules;
means of starting the sequence of drive pulses to the thermoelectric modules.

2. The apparatus of claim 1, includes a means in the control unit to disable the starting signal during drive pulses.

3. The apparatus of claim 1, wherein a thermoelectric module includes a thermoelectric junction with the cold side of said junction positioned against the user and the hot side of said junction facing away from the user.

4. The apparatus of claim 3, wherein the cold side of the thermoelectric junction causes the driver discomfort as the temperature of said junction decreases during a drive pulse.

5. The apparatus of claim 3, wherein the cold side of the thermoelectric junction causes the driver discomfort resulting from the transfer of heat from the heat sink through said junction to the cold plate during the absence of a drive pulse.

6. The apparatus of claim 1, wherein the duration of the drive pulse is adjustable by means of a multi-position control.

7. The apparatus of claim 1, further including a sensor input or a manual switch as a means of starting the sequential timing cycle.

8. The apparatus of claim 1, further includes an indicator, which enables the user to level an optional head tilt sensor.

9. The apparatus of claim 1, includes fused power input and a means to activate power to the control unit.

10. The apparatus of claim 7, wherein the driver activity and the pulse duration is displayed with a visual indicator.
